(19) United States
(12) Patent Application Publication
(10) Pub. No.: US 2025/0211413 A1
(43) Pub. Date: Jun. 26, 2025

(54) METHOD AND APPARATUS FOR NR DUPLEX OPERATION

(71) Applicant: APPLE INC., Cupertino, CA (US)

(72) Inventors: Haitong Sun, Cupertino, CA (US); Wei Zeng, Saratoga, CA (US); Dawei Zhang, Saratoga, CA (US); Yushu Zhang, Beijing (CN); Hong He, San Jose, CA (US); Chunxuan Ye, San Diego, CA (US); Seyed Ali Akbar Fakoorian, San Diego, CA (US)

(21) Appl. No.: 18/845,510

(22) PCT Filed: Jan. 4, 2023
(86) PCT No.: PCT/US2023/060091

§ 371 Date: Sep. 10, 2024

Related U.S. Application Data
(60) Provisional application No. 63/269,415, filed on Mar. 16, 2022.

(51) Int. Cl. H04L 5/14; H04L 5/00; H04W 8/22; H04W 56/00; H04W 76/20

(52) U.S. Cl. CPC H04L 5/1469; H04L 5/0051; H04W 8/22; H04W 56/0045; H04W 76/20

(57) ABSTRACT

Systems and methods are provided for duplex operation enhancement, including providing a user equipment (UE) preferred gap indication, UE uplink (UL) to downlink (DL) interference mitigation, enhanced broadcasting signal configurations, CE RF capability indication, or combinations thereof.

### TECHNICAL FIELD

This application relates generally to wireless communication systems, including duplex communication.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates full duplex operation in paired spectrum according to certain embodiments.

FIG. 1B illustrates half duplex operation in paired spectrum according to certain embodiments.

FIG. 1C illustrates half duplex operation in unpaired spectrum according to certain embodiments.

FIG. 2 is a timing diagram illustrating a transmission scheme including gaps according to certain embodiments.

FIG. 3 illustrates interference in a cellular communication system according to certain embodiments.

FIG. 4 illustrates a minimum frequency separation according to certain embodiments.

FIG. 5 is a timing diagram illustrating overlapping and non-overlapping SSBs according to certain embodiments.

FIG. 6 is a flowchart of a method for a UE according to one embodiment.

FIG. 7 is a flowchart of a method for a first UE for UL to DL interference mitigation according to one embodiment.

FIG. 8 is a flowchart of a method for a UE according to one embodiment.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Radio spectrum may be used in paired spectrum or unpaired spectrum configurations. For paired spectrum, a block of spectrum in a lower frequency band is associated with a block of spectrum in an upper frequency band. Frequency division duplex (FDD) is an example of paired spectrum wherein one frequency band is used for uplink (UL) and another frequency band is used for (DL). Unpaired spectrum, on the other hand, uses one frequency band for both UL and DL transmissions. Time division duplex (TDD) is an example of unpaired spectrum that uses the same frequency band at different times for UL and DL.

Duplex operation refers to bidirectional communication between two devices, whereas unidirectional communication may be referred to as simplex operation. In the bidirectional case, transmissions over a link in each direction may take place at the same time (referred to as full duplex operation) or at mutually exclusive times (referred to as half duplex operation). In certain cellular communication systems, each device (e.g., base station or UE) is not expected to operate in both DL and UL (i.e., transmission and reception operation) simultaneously in the same frequency due to interference between transmission and reception radio resources (i.e., time and frequency resources).

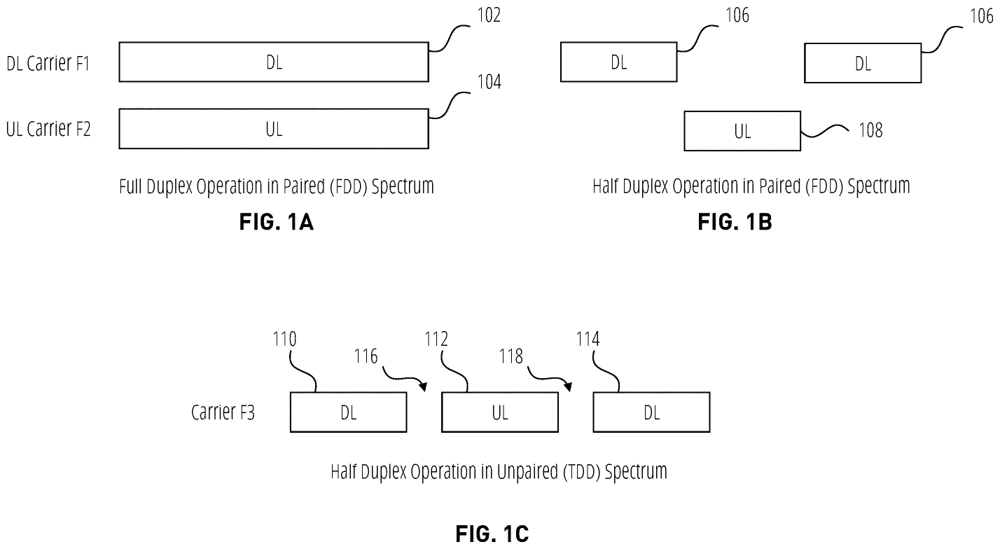

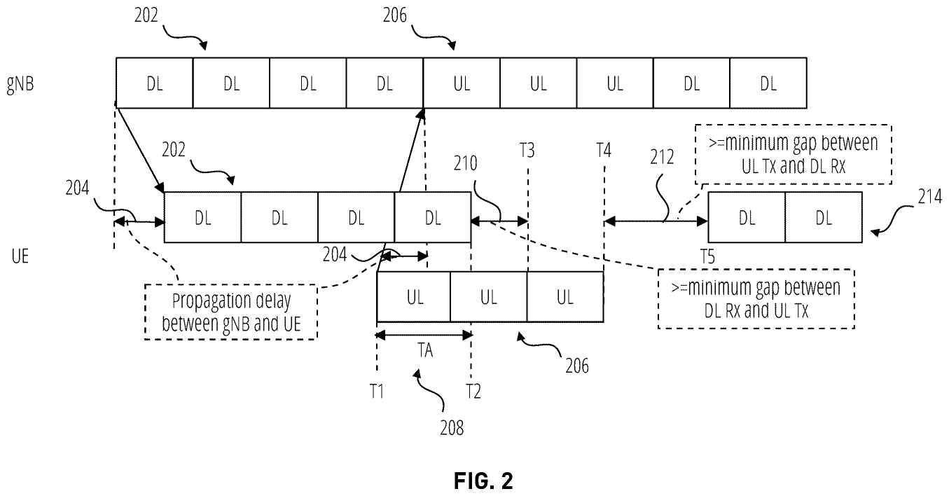

For paired spectrum (i.e., FDD), NR communication systems may support both full duplex and half duplex operation. FIG. 1A illustrates full duplex operation in paired spectrum according to certain embodiments. DL resources 102 are configured in a DL carrier frequency band (F1) that is different than a UL carrier frequency band (F2) used for UL resources 104. Because the frequency bands do not overlap, the DL resources 102 and the UL resources 104 may be used at the same time.

FIG. 1B illustrates half duplex operation in paired spectrum according to certain embodiments. For half duplex, the DL resources 106 configured in the DL carrier frequency band are not used at the same time as UL resources 108 configured in the UL carrier frequency band.

For unpaired spectrum (i.e., TDD), certain NR communication systems only support half duplex operation. For example, FIG. 1C illustrates half duplex operation in unpaired spectrum according to certain embodiments. In the illustrated example, a single carrier frequency band (F3) is used for DL resources 110, 114 and UL resources 112 transmitted at different times. In certain systems, there may be a gap 116 between switching from DL reception at the UE to UL transmission to account for a propagation delay based on path distance between the base station and the UE. Similarly, there may also be a gap 118 between switching from UL transmission to DL reception at the UE.

Certain cellular wireless systems may allow advanced devices to cancel the interference from the transmitter to the receiver in the same frequency band. Such advanced devices may be able to transmit and receive at the same time using the same spectrum. To provide duplex operation enhancement (e.g., duplex enhancement at the base station side and/or half duplex operation at the UE side), certain embodiments disclosed herein provide UE preferred gap indication, UE UL to DL interference mitigation, enhanced broadcasting signal configuration, UE RF capability indication, or combinations of the foregoing.

### I. UE Preferred Gap Indication

FIG. 2 is a timing diagram illustrating a transmission scheme including gaps according to certain embodiments. A gNB (or other base station) transmits a DL signal 202 comprising one or more symbols. In this example, the DL signal 202 includes four symbols. The DL signal 202 arrives at a UE after a propagation delay 204. Skilled persons will recognize that the UE may use a timing advance (TA) scheme to control transmission timing of a UL signal 206. For example, the gNB may measure time differences between UL transmissions and a subframe time and may send a TA command to the UE to change its uplink transmission by an indicated amount of time to make it better aligned with the subframe timing at the gNB. If, for example, the UL transmissions arrive at the gNB too early, the gNB may send a TA command to the UE to indicate that the UE's transmissions should start later. On the other hand, if the UL transmissions arrive at the gNB too late, the gNB may send a TA command to the UE to indicate that the UE's transmissions should start earlier.

By way of example, FIG. 2 illustrates a TA adjustment 208 made by the UE in response to a TA command from the gNB to transmit the UL signal 206 earlier by an indicated TA value. That is to say, rather than beginning transmission of the UL signal 206 at a time T2 upon completing reception of the DL signal 202, the UE advances transmission of the UL signal 206 to an earlier time T1 to account for round-trip propagation delay such that the UL signal 206 is received by the gNB when the gNB has completed transmission of the DL signal 202. However, to avoid interference between overlapping symbols of the DL signal 202 and the UL signal 206, the UE may use half duplex operation and be configured (e.g., based on a predetermined or fixed value) to use a minimum gap 210 between finishing reception of the DL signal 202 (i.e., DL reception (Rx) at time T2) and beginning transmission of the UL signal 206 (i.e., UL transmission (Tx) at time T3). In addition, or in other configurations, the UE may be configured (e.g., based on a predetermined or fixed value) to use a minimum gap 212 between finishing transmission of the UL signal 206 (i.e., UL Tx at time T4) and beginning reception of another DL signal 214 (i.e., DL Rx at time T5).

However, using a predetermined or fixed value for the minimum gap 210 between DL Rx and UL Tx, and/or for the minimum gap 212 between UL Tx and DL Rx, may result in wasting radio resources. Of the three symbols shown for the UL signal 206, in the illustrated example, the UE may only transmit the last UL symbol starting at time T3 that does not overlap in time with any of the symbols received at the UE for the DL signal 202. Thus, in this example, 66% of the UL symbols are not used.

Thus, in one embodiment, the UE indicates to the base station a preferred gap between DL Rx and UL Tx for duplex operation enhancement. The indication may, for example, either be part of radio resource (RRC) capability signaling or included in a specification. In certain embodiments, the UE indicates its capability for a preferred gap between DL Rx and UL Tx per frequency band.

In addition, or in other embodiments, the UE indicates to the base station a preferred gap between UL Tx and DL Rx for duplex operation enhancement. The indication may, for example, either be part of RRC capability signaling or included in a specification. In certain embodiments, the UE indicates its capability for a preferred gap between UL Tx and DL Rx per frequency band.

The scheduling of a UL transmission or DL reception may not meet a UE gap requirement. For example, a first one or multiple UL Tx symbols may not have enough timing offset from a last DL Rx symbol received at the UE (i.e., when switching from DL Rx to UL Tx). As another example, a last one or multiple UL Tx symbols may not have enough timing offset from a first DL Rx symbol (i.e., when switching from UL Tx to DL Rx). Thus, in certain embodiments when the scheduled UL transmission does not meet the UE gap requirement for half duplex operation, the UE is allowed to drop the UL transmission. The UE may either drop the full transmission or the UE may drop only the symbols not meeting the UE gap requirement. In certain embodiments, if a demodulation reference signal (DMRS) is dropped, the UE is allowed to shift the DMRS to a first valid symbol for UL transmission. To compute the transport block (TB) size, the UE may calculate the number of resource elements (RE) based on actual transmitted symbols.

In other embodiments when the scheduled UL transmission or DL reception does not meet the UE gap requirement for half duplex operation, the UE is allowed to drop the DL reception. The UE may either drop the full DL reception or the UE may drop only the symbols not meeting the UE gap requirement. In certain embodiments, if a DMRS is dropped, the UE expects the base station to shift the DMRS to a first valid symbol for DL reception. To compute the transport block (TB) size, the UE may calculate the number of resource elements (RE) based on actual received symbols.

### II. UE UL to DL Interference Mitigation

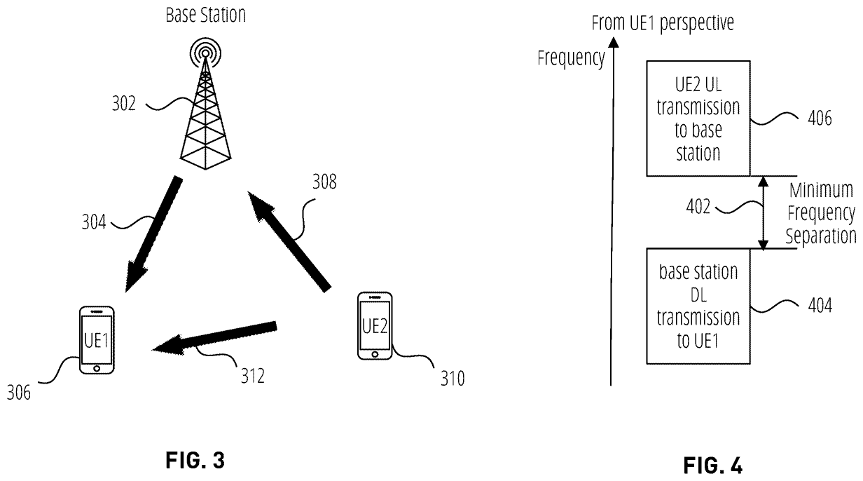

Even when a base station is capable to cancel interference between transmission and reception in the same or adjacent frequency band, a UE may not be able to achieve similar performance. As a result, the UE may still observe UL to DL interference. For example, FIG. 3 illustrates interference in a cellular communication system according to certain embodiments. In this example, a base station 302 may observe interference from transmission of a signal 304 to a first UE 306 (UE1) to a signal 308 received from a second UE 310 (UE2). Certain advanced base stations may be able to reject or reduce such interference.

The first UE 306 may observe interference from a signal 312 transmitted by the second UE 310 to the signal 304 received from the base station 302. However, the first UE 306 may be less capable to handle such interference (e.g., due to the complexity and/or cost of circuitry to reject or reduce the interference).

Thus, in one embodiment, the first UE 306 reports to the base station 302 the measurement of the signal 312 from the second UE 310. The reported measurement may be, for example, a reference signal received power (RSRP) of the signal 312 transmitted from the second UE 310 (i.e., measuring the received power of a sounding reference signal (SRS) or channel state information reference signal (CSI-RS) transmitted by the second UE 310). Based on the measurement, the first UE 306 may estimate and report (to the base station 302) a pathloss from the second UE 310. In addition, or in other embodiments, the first UE 306 may estimate and report (to the base station 302) a signal to interference noise ratio (SINR) and/or channel quality indicator (CQI) from the second UE 310.

In certain embodiments, the base station 302 configures the second UE 310 to transmit SRS for the first UE 306 to measure and report. For example, a configuration by the base station 302 of the SRS transmission by the second UE 310 may include one or more of a TA value (if needed), an SRS port, a sequence, a frequency domain resource configuration, a time domain resource configuration, and a power control configuration. The base station 302 may also configure the first UE 306 to measure and report the SRS measurement. For example, the base station 302 may configure the first UE 306 with a time offset and measurement window for SRS timing acquisition, an SRS configuration (e.g., including port, sequence, time domain resource allocation (TDRA), and frequency domain resource allocation (FDRA)), and/or SRS transmit power (e.g., if a pathloss estimate is to be estimated). The first UE 306 reports the RSRP or path loss estimate to the base station 302. The report can be periodic, semi-persistent, or aperiodic. Different UEs can have SRS multiplexed in different ports, wherein a UE may report RSRP or pathloss corresponding to each port.

In certain embodiments, when cyclic prefix-orthogonal frequency division multiplexing (CP-OFDM) is used for UL transmission, the base station 302 may configure the second UE 310 to transmit CSI-RS for the first UE 306 to measure and report. For example, a configuration by the base station 302 of the CSI-RS transmission by the second UE 310 may include one or more of a TA value (if needed), a CSI-RS port, a frequency domain resource configuration, a time domain resource configuration, and a power control configuration.

The base station 302 may also configure the first UE 306 to measure and report the CSI-RS measurement. For example, the base station 302 may configure the first UE 306 with a time offset and measurement window for CSI-RS timing acquisition, a CSI-RS configuration (e.g., including port, TDRA, and FDRA), and/or CSI-RS transmit power (e.g., if a pathloss estimate is to be estimated). The first UE 306 reports the RSRP or path loss estimate to the base station 302. The report can be periodic, semi-persistent, or aperiodic. Different UEs can have CSI-RS multiplexed in different ports, wherein a UE may report RSRP or pathloss corresponding to each port.

In certain embodiments, when the base station 302 schedules both the first UE 306 and the second UE 310 (e.g., simultaneously), while the first UE 306 receives DL (i.e., a physical downlink shared channel (PDSCH)) from the base station 302 and the second UE 310 transmits UL (i.e., physical uplink shared channel (PUSCH) to the base station 302, the base station 302 may also configure the first UE 306 to measure the PUSCH DMRS of the second UE 310. The DMRS of the second UE 310 PUSCH configuration may include at least one of a time offset and measurement window. The DMRS configuration may include one or more of a port, a time domain resource allocation power, and a frequency domain resource allocation power. The first UE 306 reports to the base station 302 one more measurement quantity including the RSRP of DMRS received from the second UE 310, the relative signal strength of the received signal from the base station 302 and received interference from the second UE 310, and/or the estimated degradation of CQI based on the received interference from the 310.

In certain embodiments, the first UE 306 may report to the base station 302 a requested minimum frequency separation between the intended DL reception and the interference caused by the UL transmission of the second UE 310 at the same time. For example, FIG. 4 illustrates a minimum frequency separation 402 according to certain embodiments. In this example, the minimum frequency separation 402 is shown from the perspective of UE1 (e.g., the first UE 306 illustrated in FIG. 3). UE1 may determine the minimum frequency separation 402 based on avoiding or reducing interference between a base station DL transmission 404 to UE1 and a UE2 UL transmission 406 to the base station.

UE1 may report the minimum frequency separation 402 as a number of physical resource blocks (PRBs) between the base station DL transmission 404 to UE1 and the UE2 UL transmission 406 to the base station. In certain embodiments, the minimum frequency separation may be a function of the bandwidth of the scheduled DL reception. For example, the bandwidth may be quantized coarsely (e.g., 40 PRBs, 80 PRBs, 120 PRBs, 160 PRBs, 200 PRBs, or 240 PRBs). In certain embodiments, the minimum frequency separation 402 may be different for different bandwidths (e.g., typically smaller for wider bandwidth). In certain embodiments, the minimum frequency separation 402 depends on a subcarrier spacing (SCS) used for the DL and UL scheduling. For example, UE1 may account for different SCS used for DL and UL when determining the minimum frequency separation 402. In certain embodiments, UE1 may report the minimum frequency separation 402 differently for different interfering UEs (i.e., from UE2 and from another UE (not shown)).

### III. Broadcasting Signal Configuration

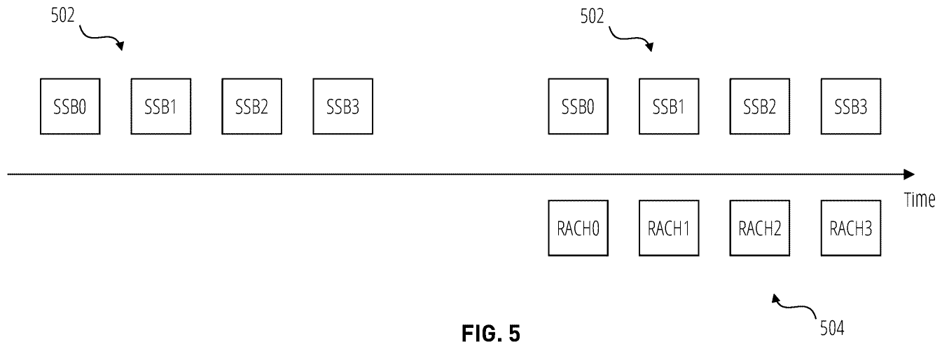

Certain embodiments provide duplex operation enhancement using broadcasting signal configurations. Cellular networks generally broadcast system information (e.g., synchronization signal blocks (SSBs)) so as to not overlap in time with random access channel (RACH) occasions so that valid RACH occasions are available to UEs (e.g., in a TDD half duplex operation) for initial access. For example, FIG. 5 is a timing diagram illustrating overlapping and non-overlapping SSBs according to certain embodiments. Specifically, FIG. 5 shows a non-overlapping example of SSBs 502 (shown as SSB0, SSB1, SSB2, and SSB3) and an overlapping example wherein RACH occasions 504 (shown as RACH0, RACH1, RACH2, and RACH3) are configured at the same time that the SSBs 502 are broadcast by the base station. In other words, the base station may configure both an SSB transmission and a corresponding RACH occasion to occur at the same time. The base station may be configured to cancel or reduce interference from simultaneously transmitting SSBs and receiving UL signals from UEs during the RACH occasions.

As discussed above, however, a UE may not have the same interference canceling or reducing capabilities as a base station. Thus, in certain embodiments when system information (e.g., master information block (MIB), remaining system information (RMSI), and/or other system information (SI)) monitoring at the UE side collides with a configured UE RACH transmission occasion, the UE may take different actions depending on whether the UE is in an idle RRC state, an inactive RRC state, or a connected RRC state. When the UE is in an idle RRC state or an inactive RRC state, when system information monitoring collides with a RACH occasion, the UE may be configured to determine for itself (i.e., without further direction from the base station) whether to monitor for system information or to perform a RACH transmission. When the UE is in a connected RRC state, when system information monitoring collides with a RACH occasion, the base station may configure the UE to either monitor for system information or to perform a RACH transmission.

### IV. UE RF Capability Indication

In certain embodiments, for each frequency band, the UE can indicate to the base station whether it can operate with enhanced duplex operation. In other words, the UE may indicate whether it can be scheduled with DL and/or UL operation simultaneously with UL and/or DL operation of another UE or itself. For unpaired spectrum (i.e., TDD band), the UE may report the capability per frequency band. For paired spectrum (i.e., FDD band), the UE may report the capability separately for DL and UL frequency bands.

In certain embodiments, for each frequency band in intra-band carrier aggregation (CA) or dual connectivity (DC), the UE is configured to signal whether it supports mixed duplexing direction. If the UE does not support mixed duplexing direction, for intra-band CA and DC, the base station can only configure the UE with the same duplexing direction for all component carriers (CCs) within the same band (i.e., either all DL or all UL).

In certain embodiments, for each frequency band in intra-band CA or DC, the UE is configured to signal the minimum duplexing distance D (i.e., frequency separation) for a mixed duplexing direction. For example, for a first CC frequency F1 having a UL center frequency at F_ul with a bandwidth (BW) BW_ul, and a second CC frequency F2 having a DL center frequency at F_dl with BW BW_dl, the UE can only be schedule for both DL on F2 and UL on FI when min (|F_ul±(BW_ul/2)−F_dl±(BW_dl/2)|)≥D.

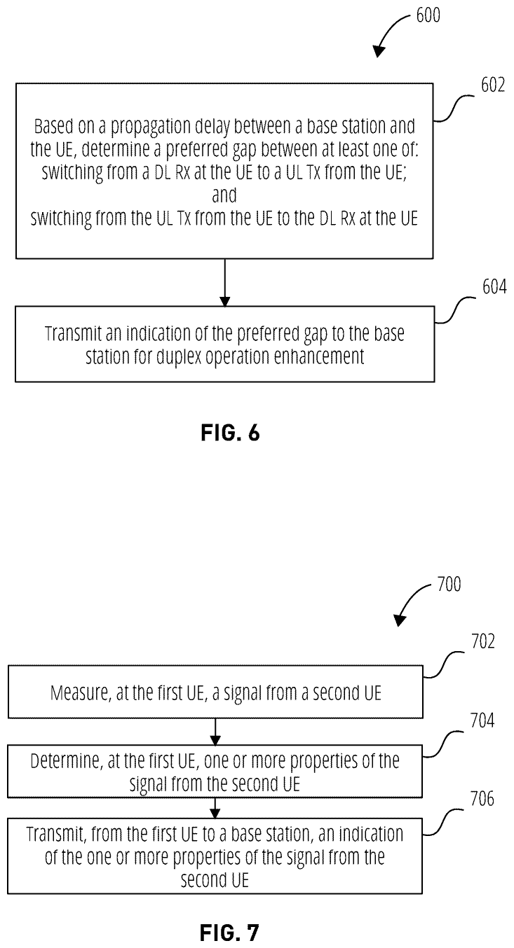

FIG. 6 is a flowchart of a method 600 for a UE according to one embodiment. In block 602, the method 600 includes, based on a propagation delay between a base station and the UE, determining a preferred gap between at least one of: switching from a DL Rx at the UE to a UL Tx from the UE; and switching from the UL Tx from the UE to the DL Rx at the UE. In block 604, the method 600 includes transmitting an indication of the preferred gap to the base station for duplex operation enhancement.

In certain embodiments of the method 600, transmitting the indication comprises including the indication in radio resource control (RRC) capability signaling from the UE to the base station. The RRC capability signaling may communicate the indication of the preferred gap per frequency band.

In certain embodiments of the method 600, the preferred gap is further based on a timing advance (TA).

Certain embodiments of the method 600 further include, in response to determining that a configured grant for the UL Tx does not satisfy a UE gap requirement, dropping at least part of the UL Tx or the DL Rx.

In certain embodiments, dropping includes the UE skipping transmission of all UL symbols of the configured UL grant. In another embodiment, the dropping includes the UE skipping transmission of only one or more symbols of the configured UL grant that do not satisfy the UE gap requirement. When the one or more symbols include a demodulation reference signal (DMRS), the UE shifts the DMRS to a first valid symbol of the configured UL grant. The method 600 may include calculating a number of resource elements (RE) based on actual transmitted symbols to compute a transport block (TB) size.

In other embodiments, dropping includes the UE skipping reception of all DL symbols of the DL Rx.

In other embodiments, dropping includes the UE skipping reception of only one or more symbols of the DL Rx that do not satisfy the UE gap requirement. When the one or more symbols include a demodulation reference signal (DMRS), the UE expects the base station to shift the DMRS to a first valid symbol of DL Rx. The method 600 may further include calculating a number of resource elements (RE) based on actual received symbols to compute a transport block (TB) size.

FIG. 7 is a flowchart of a method 700 for a first UE for UL to DL interference mitigation according to one embodiment. In block 702, the method 700 includes measuring, at the first UE, a signal from a second UE. In block 704, the method 700 includes determining, at the first UE, one or more properties of the signal from the second UE. In block 706, the method 700 includes transmitting, from the first UE to a base station, an indication of the one or more properties of the signal from the second UE.

In certain embodiments of the method 700, the one or more properties is selected from a group comprising an estimated path loss from the second UE, an estimated signal to interference noise ratio (SINR), and an estimated channel quality indicator (CQI).

In certain embodiments of the method 700, the signal from the second UE comprises a sounding reference signal (SRS) or a channel state information reference signal (CSI-RS), and wherein the one or more properties comprises a reference signal received power (RSRP) or an estimated path loss from the second UE.

When the signal comprises the SRS, the first UE is configured by the base station to measure and report an SRS measurement including one or more of: a time offset and measurement window for SRS timing acquisition; an SRS configuration including port, sequence, time domain resource allocation (TDRA), and frequency domain resource allocation (FDRA); and an SRS transmit power to determine the estimated path loss, if needed. In certain embodiments, the method 700 further includes reporting, from the first UE to the base station, the RSRP or the estimated path loss, wherein the reporting is periodic, semi-persistent, or aperiodic. In certain embodiments, the SRS is multiplexed in different ports, and the method 700 further includes reporting, from the first UE to the base station, the RSRP or the estimated path loss corresponding to each port.

When the signal comprises the CSI-RS, the first UE is configured by the base station to measure and report a CSI-RS measurement including one or more of: a time offset and measurement window for CSI-RS timing acquisition; a CSI-RS configuration including port, sequence, time domain resource allocation (TDRA), and frequency domain resource allocation (FDRA); and a CSI-RS transmit power to determine the estimated path loss, if needed. In certain embodiments, the method 700 further includes reporting, from the first UE to the base station, the RSRP or the estimated path loss, wherein the reporting is periodic, semi-persistent, or aperiodic. In certain embodiments, the CSI-RS is multiplexed in different ports, and the method 700 further includes reporting, from the first UE to the base station, the RSRP or the estimated path loss corresponding to each port.

In certain embodiments, the first UE is configured by the base station to measure a physical uplink shared channel (PUSCH) demodulation reference signal (DMRS) from the second UE, and the method 700 further includes reporting, from the first UE to the base station, one or more measurement quantity selected from a group comprising: a reference signal received power (RSRP) of the DMRS received from the second UE; a relative signal strength of a received signal from the base station and interference received from the second UE; and an estimated degradation of a channel quality indicator (CQI) based on the interference received from the second UE.

In certain embodiments, the method 700 further includes reporting, from the first UE to the base station, a requested minimum frequency separation between a scheduled DL reception at the first UE and interference by a UL transmission from the second UE. The requested minimum frequency separation may be reported as a number of physical resource blocks. The requested minimum frequency separation may comprise a function of a bandwidth of the scheduled DL reception, and the requested minimum frequency separation may be different for different bandwidths. The requested minimum frequency separation may be based on a subcarrier spacing (SCS) used for at least one of a DL scheduling and an UL scheduling.

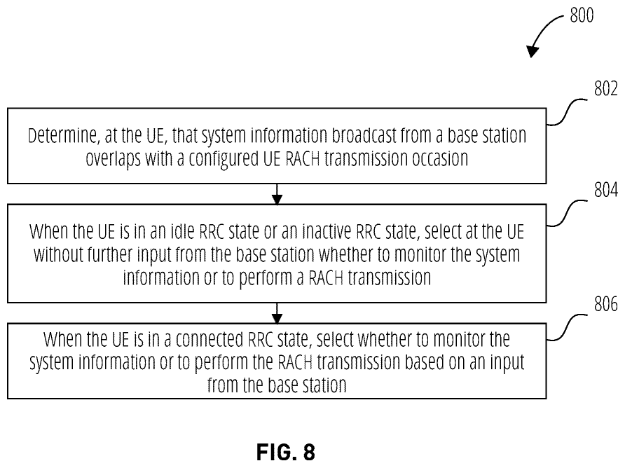

FIG. 8 is a flowchart of a method 800 for a UE according to one embodiment. In block 802, the method 800 includes determining, at the UE, that system information broadcast from a base station overlaps with a configured UE RACH transmission occasion. At block 804, when the UE is in an idle RRC state or an inactive RRC state, the method 800 includes selecting at the UE without further input from the base station whether to monitor the system information or to perform a RACH transmission. At block 806, when the UE is in a connected RRC state, the method 800 includes selecting whether to monitor the system information or to perform the RACH transmission based on an input from the base station.

In certain embodiments, the method 800 further includes reporting, from the UE to the base station, whether the UE can be configured to operate in an enhanced duplex operation, wherein for unpaired spectrum the reporting is per frequency band, and wherein for paired spectrum the reporting is separate for a downlink (DL) frequency band and an uplink (UL) frequency band.

In certain embodiments, the method 800 further includes reporting, for each frequency band in intra-band carrier aggregation (CA) or dual connectivity (DC), whether the UE supports mixed duplexing direction. When the UE does not support mixed duplexing direction, for intra-band CA and DC, the UE is only configured with a same duplexing direction for component carriers (CCs) in the same frequency band.

In certain embodiments, the method 800 further includes, for each frequency band in intra-band carrier aggregation (CA) or dual connectivity (DC), signaling from the UE to the base station a minimum duplexing distance for mixed duplexing direction.

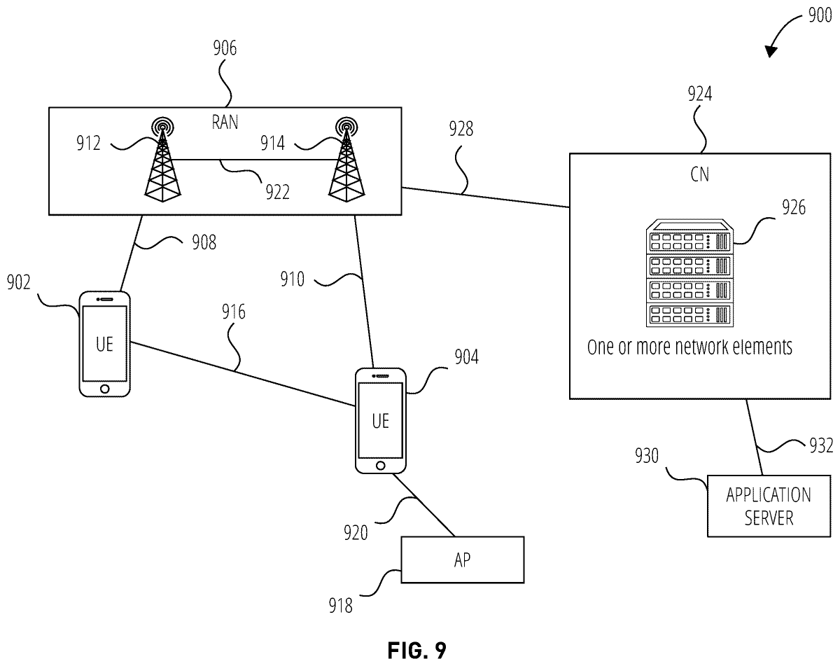

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations, such as base station 912 and base station 914, which enable the connection 908 and the connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-FiR router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VOIP sessions, group communication sessions, etc.) for the UE 902 and UE 904 via the CN 924. The application server 930 may communicate with the CN 924 through an IP communications interface 932.

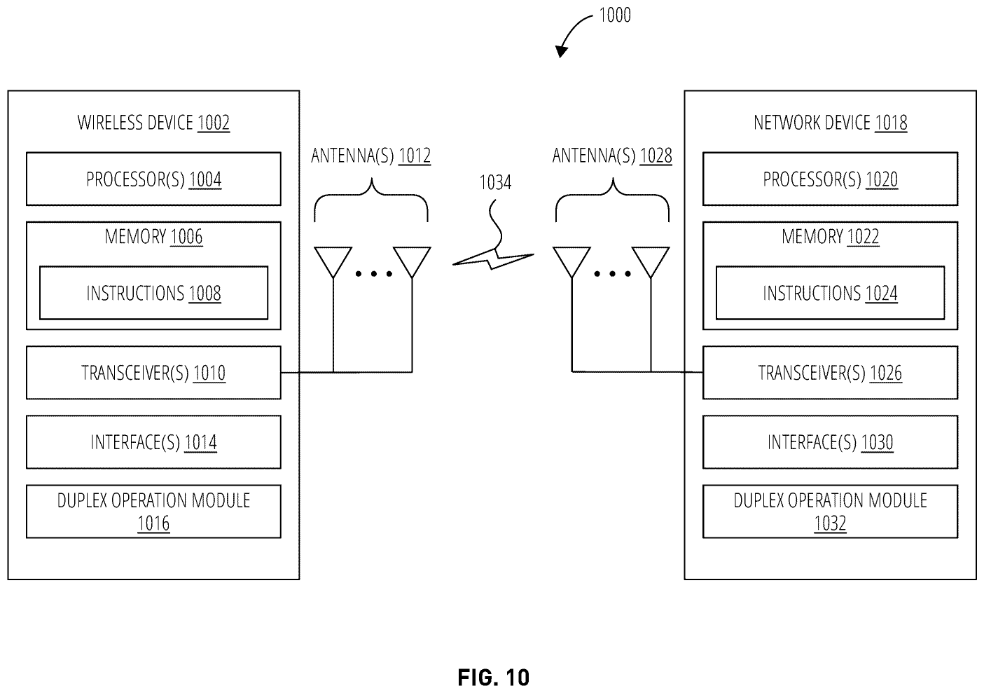

FIG. 10 illustrates a system 1000 for performing signaling 1034 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1034) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include a duplex operation module 1016. The duplex operation module 1016 may be implemented via hardware, software, or combinations thereof. For example, the duplex operation module 1016 may be implemented as a processor, circuit, and/or instructions 1008 stored in the memory 1006 and executed by the processor(s) 1004. In some examples, the duplex operation module 1016 may be integrated within the processor(s) 1004 and/or the transceiver(s) 1010. For example, the duplex operation module 1016 may be implemented by a combination of software components (e.g., executed by a DSP or a general processor) and hardware components (e.g., logic gates and circuitry) within the processor(s) 1004 or the transceiver(s) 1010.

The duplex operation module 1016 may be used for various aspects of the present disclosure, for example, aspects of FIG. FIG. 6 to FIG. 8.

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter and/or receiver circuitry that use the antenna(s) 1028 of the network device 1018 to facilitate signaling (e.g., the signaling 1034) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1018 may include a duplex operation module 1032. The duplex operation module 1032 may be implemented via hardware, software, or combinations thereof. For example, the duplex operation module 1032 may be implemented as a processor, circuit, and/or instructions 1024 stored in the memory 1022 and executed by the processor(s) 1020. In some examples, the duplex operation module 1032 may be integrated within the processor(s) 1020 and/or the transceiver(s) 1026. For example, the duplex operation module 1032 may be implemented by a combination of software components (e.g., executed by a DSP or a general processor) and hardware components (e.g., logic gates and circuitry) within the processor(s) 1020 or the transceiver(s) 1026.

The duplex operation module 1032 may be used for various aspects of the present disclosure.

Embodiments contemplated herein include an apparatus comprising means to perform one or more elements of the methods for a UE described herein. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the methods for a UE described herein. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the methods for a UE described herein. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the methods for a UE described herein. This apparatus may be, for example, an apparatus of a UE (such as a wireless device 1002 that is a UE, as described herein).

Embodiments contemplated herein include a signal as described in or related to one or more elements of the methods for a UE described herein.

Embodiments contemplated herein include a computer program or computer program product comprising instructions, wherein execution of the program by a processor is to cause the processor to carry out one or more elements of the methods for a UE described herein. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Embodiments contemplated herein include an apparatus comprising means to perform one or more elements of the methods for a base station described herein. This apparatus may be, for example, an apparatus of a base station (such as a network device 1018 that is a base station, as described herein).

Embodiments contemplated herein include one or more non-transitory computer-readable media comprising instructions to cause an electronic device, upon execution of the instructions by one or more processors of the electronic device, to perform one or more elements of the methods for a base station described herein. This non-transitory computer-readable media may be, for example, a memory of a base station (such as a memory 1022 of a network device 1018 that is a base station, as described herein).

Embodiments contemplated herein include an apparatus comprising logic, modules, or circuitry to perform one or more elements of the methods for a base station described herein. This apparatus may be, for example, an apparatus of a base station (such as a network device 1018 that is a base station, as described herein).

Embodiments contemplated herein include an apparatus comprising: one or more processors and one or more computer-readable media comprising instructions that, when executed by the one or more processors, cause the one or more processors to perform one or more elements of the methods for a base station described herein. This apparatus may be, for example, an apparatus of a base station (such as a network device 1018 that is a base station, as described herein).

Embodiments contemplated herein include a signal as described in or related to one or more elements of the methods for a base station described herein.

Embodiments contemplated herein include a computer program or computer program product comprising instructions, wherein execution of the program by a processing element is to cause the processing element to carry out one or more elements of the methods for a base station described herein. The processor may be a processor of a base station (such as a processor(s) 1020 of a network device 1018 that is a base station, as described herein). These instructions may be, for example, located in the processor and/or on a memory of the base station (such as a memory 1022 of a network device 1018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
based on a propagation delay between a base station and the UE, determining a preferred gap between at least one of:
switching from a downlink (DL) reception (Rx) at the UE to an uplink (UL) transmission (Tx) from the UE; and
switching from the UL Tx from the UE to the DL Rx at the UE; and
transmitting an indication of the preferred gap to the base station for duplex operation enhancement.

2. The method of claim 1, wherein transmitting the indication of the preferred gap comprises including the indication of the preferred gap in radio resource control (RRC) capability signaling from the UE to the base station.

3. The method of claim 2, wherein the RRC capability signaling communicates the indication of the preferred gap per frequency band.

4. The method of claim 1, wherein the preferred gap is further based on a timing advance (TA).

5. The method of claim 1, further comprising, in response to determining that a configured grant for the UL Tx does not satisfy a UE gap requirement, dropping at least part of the UL Tx or the DL Rx.

6. The method of claim 5, wherein the dropping comprises the UE skipping transmission of all UL symbols of the configured UL grant.

7. The method of claim 5, wherein the dropping comprises the UE skipping transmission of only one or more symbols of the configured UL grant that do not satisfy the UE gap requirement.

8. The method of claim 7, wherein when the one or more symbols include a demodulation reference signal (DMRS), the UE shifts the DMRS to a first valid symbol of the configured UL grant.

9. The method of claim 7, further comprising calculating a number of resource elements (RE) based on actual transmitted symbols to compute a transport block (TB) size.

10. The method of claim 5, wherein the dropping comprises the UE skipping reception of all DL symbols of the DL Rx.

11. The method of claim 5, wherein the dropping comprises the UE skipping reception of only one or more symbols of the DL Rx that do not satisfy the UE gap requirement.

12. The method of claim 11, wherein when the one or more symbols include a demodulation reference signal (DMRS), the UE expects the base station to shift the DMRS to a first valid symbol of DL Rx.

13. The method of claim 11, further comprising calculating a number of resource elements (RE) based on actual received symbols to compute a transport block (TB) size.

14. A method for a first user equipment (UE) for uplink (UL) to downlink (DL) interference mitigation, the method comprising:
measuring, at the first UE, a signal from a second UE;
determining, at the first UE, one or more properties of the signal from the second UE;
transmitting, from the first UE to a base station, an indication of the one or more properties of the signal from the second UE.

15. The method of claim 14, wherein the one or more properties is selected from a group comprising an estimated path loss from the second UE, an estimated signal to interference noise ratio (SINR), and an estimated channel quality indicator (CQI).

16. The method of claim 14, wherein the signal from the second UE comprises a sounding reference signal (SRS) or a channel state information reference signal (CSI-RS), and wherein the one or more properties comprises a reference signal received power (RSRP) or an estimated path loss from the second UE.

17. The method of claim 16, wherein when the signal comprises the SRS, the first UE is configured by the base station to measure and report an SRS measurement including one or more of:
a time offset and measurement window for SRS timing acquisition:
an SRS configuration including port, sequence, time domain resource allocation (TDRA), and frequency domain resource allocation (FDRA); and
an SRS transmit power to determine the estimated path loss, if needed.

18. The method of claim 17, further comprising reporting, from the first UE to the base station, the RSRP or the estimated path loss, wherein the reporting is periodic, semi-persistent, or aperiodic.

19. The method of claim 17, wherein the SRS is multiplexed in different ports, and wherein the method further comprises reporting, from the first UE to the base station, the RSRP or the estimated path loss corresponding to each port.

20. The method of claim 16, wherein when the signal comprises the CSI-RS, the first UE is configured by the base station to measure and report a CSI-RS measurement including one or more of:
a time offset and measurement window for CSI-RS timing acquisition;
a CSI-RS configuration including port, sequence, time domain resource allocation (TDRA), and frequency domain resource allocation (FDRA); and
a CSI-RS transmit power to determine the estimated path loss, if needed.

21-34. (canceled)
